(19) United States
(12) Patent Application Publication
(10) Pub. No.: US 2002/0120580 A1
(43) Pub. Date: Aug. 29, 2002

(54) Secure data transfer apparatus and method

(76) Inventor: Robert C. Mayes, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/792,856

(22) Filed: Feb. 23, 2001

(51) Int. Cl. G06F 17/60; H04K 1/00; H04L 9/00

(52) U.S. Cl. 705/64; 705/39

(57) ABSTRACT

For wireless devices (36), a secure data transfer apparatus (10) includes a cabinet (12) movable between an open position (14) for receiving a wireless device (36) and a closed position (16) for sealing the wireless device (36) within the cabinet (12). At least one communications sensor (26) is located inside the cabinet (12) for transferring secure data to and from the wireless device (36). A secure communications device (20) is connected to the at least one communications sensor (26) and to a data source (32) external to the cabinet (12) for transferring secure data to and from the at least one communications sensor (26). A command device (34) is connected to the cabinet (12) for operating the at least one communications sensor (26) and directing the transfer of the secure data to and from the wireless device (36) within cabinet (12) in the closed position (16).

### FIELD OF THE INVENTION

The present invention relates generally to the secure transfer of data. In particular, the present invention relates to a system for the secure transfer of data to wireless devices.

### BACKGROUND OF THE INVENTION

Over the course of time, electronic appliances have grown in complexity and capability while shrinking in size. Household appliances, cell phones, watches, smart cards, personal digital assistants (PDAs), are representative of an ever-increasing array of electronic devices meant to simplify users lives. Each of these devices exhibits the tension between increased capability and decreased size. In order to accommodate these tensions, many devices utilize extremely small input keys or buttons for use in inputting data and programming the device. As the need for increased control over wireless devices has accelerated, the difficulty in using these miniaturized keys and or buttons has been a constant source of frustration.

An additional issue that has developed with the growth of wireless devices is the issue of security. Along with the ease and the rapidity with which information may be transferred between wireless devices comes the need for ensuring that the information transferred is secure from access by unauthorized individuals. “Listening devices” are known which enable the user to gain unauthorized access to information transferred by and between wireless devices. As the volume of such information increases, so does the need to ensure that only authorized individuals receive the information.

A further issue, related to the increasing volumes of data transmitted by wireless devices, concerns interference with transmitted data signals. As the use of wireless devices has surged, the incidence of interference with transmitted signals has increased. Further, as volume has increased, the incidence of contamination of signals and the receipt of defective signals in the transfer of information has also grown. Additionally, it is not at all uncommon for a single user to utilize multiple wireless devices, an Internet pendant, watch, cell phone and smart cards, for example, at the same time. As a result, the need exists to ensure that information transferred to and from a wireless device is in fact received by the appropriate and intended wireless device.

Thus, there is a need in the art for an apparatus and method for providing for the secure transfer of data to wireless devices whereby the need for the use of awkward miniaturized keys and or buttons is eliminated, the transfer data is secure against unauthorized access, and interference free data transfers are enabled.

### SUMMARY OF THE INVENTION

Accordingly, the secure data transfer apparatus for wireless devices of the present invention includes a cabinet movable between an open position for receiving a wireless device and a closed position for sealing the wireless device within the cabinet. At least one communications sensor, inside the cabinet, is provided for transferring secure data to and from the wireless device. A secure communications device is connected to the at least one communications sensor and to a data source external to the cabinet for transferring secure data to and from the at least one communications sensor. A command device is connected to the cabinet for operating the at least one communications sensor and directing the transfer of secure data to and from the wireless device within the cabinet in the closed position.

In a preferred embodiment of the invention, the at least one communications sensor is selected from a group of communications sensors including radio frequency (RF) and infrared (IR). In a further preferred embodiment, multiple communications sensors are provided. In another preferred embodiment the secure communication device is a hardwired connection to and between the communications sensor and the data source. In one preferred embodiment, the command device is a keyboard external of, and attached to, the cabinet. In a further preferred embodiment, the data source is the Internet.

In another preferred embodiment of the invention, a method of transferring secure data to and from a wireless device includes the steps of providing a cabinet movable between an open position for receiving the wireless device and a closed position for sealing the wireless device within the cabinet. At least one communications sensor is attached inside the cabinet for transferring data to and from the wireless device. A secure communication device is connected to the at least one communications sensor and to a data source external to the cabinet for transferring secure data to and from the at least one communications sensor. A command device is connected to the cabinet for operating the at least one communications sensor and for directing the transfer of secure data to and from the wireless device within the cabinet. The wireless device is inserted within cabinet and the cabinet is placed in the closed position. Finally, the command device is operated and secure data is transferred to and from the wireless device.

In a further preferred embodiment of the invention, where a cabinet movable between an open position for receiving a wireless device and a closed position for sealing the wireless device within the cabinet is provided, computer code recorded on a computer readable medium for secure data transfer includes at least one communications sensor code for transferring secure data to and from the wireless device. A secure communication code is linked to the at least one communications sensor code and to a data source external to the cabinet for transferring secure data to and from the at least one communications sensor program code. Command code is linked to the cabinet for operating the at least one communications sensor code and for directing the transfer of the secure data to and from the wireless device within the cabinet in the closed position.

### BRIEF DESCRIPTION OF THE DRAWINGS

Other objects, features, and advantages of the present invention will become more fully apparent from the following detailed description of the preferred embodiment, the appended claims and the accompanying drawings in which:

FIG. 1 is a perspective view of the secure data transfer apparatus of the present invention;

FIG. 2 is an illustration of a variety of wireless devices for use with the invention illustrated in FIG. 1; and

FIG. 3 is a flow diagram of the secure data transfer method of the present invention.

### DETAILED DESCRIPTION OF THE INVENTION

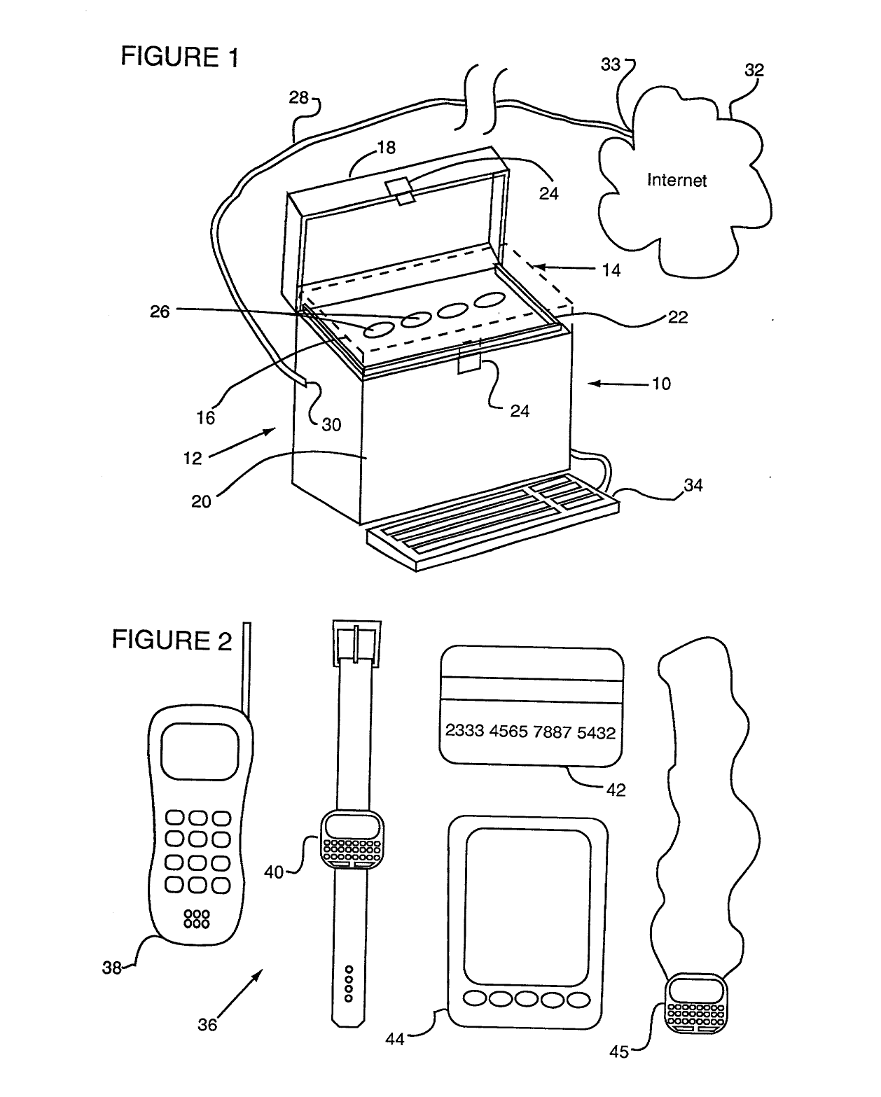

The preferred embodiment of the present invention is illustrated by way of example in FIGS. 1-3. With specific reference to FIGS. 1 and 2, secure data transfer apparatus 10 includes cabinet 12 movable between open position 14 as illustrated and closed position 16 (shown in dotted lines). Cabinet 12 includes top 18 and receiver base 20. Additionally, cabinet 12 includes seal 22 and locking device 24.

At least one communications sensor 26 is located on the inside, that is the interior, of cabinet 12. A secure communications device 28 is connected through the cabinet 12 to the at least one communications sensor 26 on one end 30 and to a data source 32 at the other end 33.

A command device 34 is connected to the cabinet 12 for operating the communications sensor 26 and for directing the transfer of secure data to and from a wireless device 36 after a wireless device 36 is placed inside cabinet 12 and the top 18 is placed in the closed and sealed position 16.

Wireless devices 36 include, for the purposes of illustration, cell phone 38, watch 40, smart card 42, PDA 44 and Internet pendant 45. Obviously, any wireless device 36 known now or hereafter developed is within the scope of the present invention. In one embodiment of the present invention, a general purpose cabinet 12 is provided with a plurality of sensors 26, including as an option a wired connection inside. This general purpose version is capable of sealing all internal communications from outside reception, as well as preventing outside signals from entering the programming process underway within the cabinet 12. This general purpose version further has the multiplicity of capability which would be generally commercially beneficial to receive a variety of useful wireless devices 36.

By way of a more complete explanation, cabinet 12 may be of any design that accomplishes the purposes of the invention. That is to say, cabinet 12 does not need to be a box per se. Any receptacle that receives a wireless device 36 and keeps the wireless device 36 in shielded seclusion, is appropriate. A clamshell design, for example, works just as well as the box illustrated in FIG. 1. Additionally, cabinet 12 may be made of any material now known or hereafter developed that forms an effective physical and electronic seal between the outside of cabinet 12 and the inside of cabinet 12. The requirement is simply that the wireless device 36 is shielded from any outside interference, electronic or otherwise, once the wireless device 36 is placed within cabinet 12 and top 18 is placed in the closed position 16. In this regard, the shielding is against any and all types of interference, i.e., electrical, electrical mechanical, radio frequency, infrared, magnetic, or the like.

Seal 22 may be simply the machined integration of top 18 with the receiver base 20 as may be obtained by a tongue and groove connection. Likewise, seal 22 may also include a separate material, metal, plastic, rubber, for example, so long as the result is the same i.e. wireless device 36 is shielded from interference inside cabinet 12 when top 18 is closed. One further example is a metal wire laced curtain fabric cover.

In a preferred embodiment, again, there is at least one communications sensor 26 located on the inside of cabinet 12. Communications sensor 26 may be of any type now known or hereafter developed for communication with wireless devices 36. In a preferred embodiment cabinet 12 includes multiple communications sensors 26 of various types. That is to say, there may be direct electrical connections with wireless devices 36, there may be RF connections, and there may be IR connections, for example. There may be one of each within cabinet 12. The objective of the secure data transfer apparatus 10 of the present invention is to make the invention assessable for use by any kind of wireless device 36. As a result, any type of communications sensor 26 necessary to communicate with wireless device 36 is appropriate.

Locking device 24 cooperates with seal 22 to ensure the security of wireless device 36 once in place inside cabinet 12. Locking device 24 may be of any known type, electrical, electrical mechanical, or the like. Just as secure communications device 28 and communications sensors 26 are controlled by command device 34, as will be discussed more fully hereafter, locking device 24 is also, in a preferred embodiment, operable by command device 34.

Secure communications device 28 is connected to the at least one communications sensor 26 through cabinet 12 at one end 30. In a preferred embodiment, secure communications device 28 is a hardwire connection. In this embodiment, secure communications device 28 directly connects cabinet 12, and other components discussed above, with remote data source 32 through the connection at the opposite end 33. This hardwire connection is impervious to eavesdropping and electronic snooping of any kind thereby ensuring the secure transfer of confidential data from remote data source 32 to wireless device 36 within cabinet 12.

Data source 32 may be any data source now known or hereafter developed containing information necessary for testing, programming, and/or adding useful information to wireless device 36. In a preferred embodiment, remote data source 32 is the Internet. By means of the Internet, as is known in the art, an infinite number of options are available as a data source for wireless device 36. For example, in the instance where wireless device 36 is a smart card 42, data source 32 includes a banking facility of a user's choice whereby a user could replenish his or her credit or debit card at a location remote from the bank in a totally secure manner over the Internet.

Command device 34, in a preferred embodiment, is a keyboard attached to the outside of cabinet 12 and connected to communications sensors 26 and secure communications device 28. Such a keyboard may be fully integrated into the cabinet 12 or the cabinet cover. Again, by means of command device 34, communications sensor 26 is controlled and the transfer of secure data is directed to and from the wireless device 36. All this occurs, again, while wireless device 36 is secure within cabinet 12 in its closed position 16 and shielded against all outside interference. Any command device 34 other than a keyboard, such as a touchpad, or the like, may be used as well.

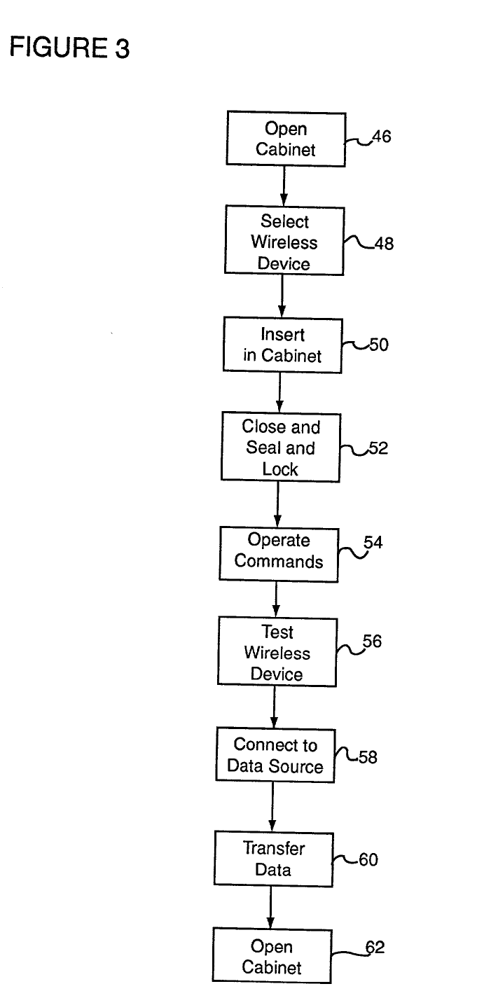

Referring now to FIG. 3, the method of transferring secure data to and from a wireless device 36 is discussed. In a preferred embodiment of the method of the present invention, a cabinet 12 is provided that is movable between an open position 14 and a closed position 16. When in the open position 14, wireless device 36 is placed within cabinet 12. Once wireless device 36 has been placed within cabinet 12, top18 may be closed so as to seal cabinet 12 and wireless device 36 from outside interference. At least one communications sensor 26 is attached inside the cabinet 12 for transferring data to and from the wireless device 36. A secure communications device 28 is connected to the at least one communications sensor 26 and to a data source 32 external to the cabinet 12. The secure communications device 28 serves the purpose of facilitating the transfer of secure data to and from the at least one communications sensor 26. A command device 34 is connected to the cabinet 12 for operating the at least one communications sensor 26 and directing the transfer of secure data to and from the wireless device 36 within cabinet 12. After the wireless device 36 has been inserted within cabinet 12, the top 18 placed in the closed position 16, and the cabinet 12 sealed against outside interference, a user operates the command device 34 so as to transfer secure data from the data source 32 to and from wireless device 36.

By way of further explanation, and still referring to FIG. 3, the steps of the method may be envisioned as follows. A user first opens cabinet 12 at step 46. Next, a user selects any appropriate wireless device 36, for instance any one of the wireless devices illustrated in FIG. 2, at step 48. Next, the user inserts wireless device 36 in cabinet 12 at step 50. Next, the user closes, seals, and locks cabinet 12 at step 52. At this point, in a preferred embodiment, the user operates command device 34 at step 54. The operation of command device 34, in a preferred embodiment, commences with the testing of wireless device 36 for operability and authenticity to ensure that it is the appropriate and/or authorized wireless device 36 at step 56. Alternatively, in a general purpose cabinet 12, a plurality of interrogations are rapidly transmitted to the contained device using in sequence, each of the available sensor types to establish an initial communication link with the contained device 36. Once a user is assured that the wireless device 36 is the appropriate device, that it is ready to receive data and that the commands have been received by the wireless device without interference, contamination or disruption, the user utilizes secure communications device 28 to connect cabinet 12, and wireless device 36, to the remote data source 32 at step 58. Again, in a preferred embodiment, the remote data source 32 is the Internet. Once connected, the user utilizes command device 34 to ensure the transfer of data in a secure means from the remote data source 32 to wireless device 36 at step 60. Finally, after the manipulation, programming, loading, or calibrating of wireless device 36 has been successfully completed, top 18 is opened in cabinet 12 at step 62 and wireless device 36 is removed.

In a preferred embodiment of the method, the communications sensor 26 is selected from a group of communications sensors including RF and IR. Additionally, in a preferred embodiment, multiple communications sensors 26 are located within cabinet 12. Still further, in a preferred embodiment, the step of connecting a secure communications device 28 includes a hardwire connection to the communications sensor 26 and to the data source 32.

In another preferred embodiment, a keyboard is connected to cabinet 12 as a command device 34. In yet another preferred embodiment, the step of connecting to a remote data source 32 comprises the step of connecting to the Internet. This may be with the use of a web browser. In a further embodiment, wireless device 36 is selected from a group including PDAs 44, cellphones 38, smart cards 42, watches 40, and Internet pendants 45.

The secure data transfer invention 10, in a preferred embodiment, is also embodied in computer code recorded on a computer readable medium. In this preferred embodiment, in a cabinet 12 movable between an open position 14 for receiving a wireless device 36 and a closed position 16 for sealing the wireless device 36 within the cabinet 12, at least one communications sensor code is provided for transferring secure data to and from the wireless device 36. Secure communications code is linked to the at least one communications sensor code and to a data source 32 external to the cabinet 12. The secure communication code transfers secure data to and from the at least one communications sensor code. Further, command code is linked to the cabinet 12 for operating the at least one communications sensor code and for directing the transfer of secure data to and from the wireless device 36 within cabinet 12 in the closed position 16. In another preferred embodiment, the at least one communications sensor code is selected from a group of communications sensor code including RF and IR. Additionally, in a preferred embodiment computer code for multiple communications sensors 26 is provided. In a still further preferred embodiment, the command computer code is computer code for a keyboard. Finally, in a preferred embodiment, the computer code for connecting to a data source 32 includes computer code for connecting to the Internet.

By way of the secure data transfer apparatus and method 10 of the present invention, programming of a wireless device 36 is permitted at any customer assessable location, when the wireless device 36 may not have an input capability or only a limited input capability, such as found with a watch 40 or other small devices. Importantly, by way of the present invention, the data transfer, programming, loading and so forth is accomplished in a secure and non-infringing manner. By way of non-infringing it is meant that the programming does not interfere with other wireless devices 36 which may be in the user's possession and nearby at the time. Currently, most wireless devices 36 are self-programmable. By way of the present invention, however, many future devices and appliances will benefit from the cost reduction from the elimination of the input capability. That is, the miniaturized buttons that are awkward to use may be reduced or eliminated altogether. In any event, any wireless device 36, in accordance with the present invention, either with or without its own input capability may be securely and safely “accessed and programed”. This would include uploading e-books to a portable electronic reading aid, upgrading internal programming, etc. Thus, for example, money can be added to a smart card 42 from a user's account securely connected through secure communications device 28 to a user's bank via the Internet, while all along assuring the privacy of the transaction. Further, by way of the present invention, a user is able to select one particular wireless device 36 from many such wireless devices in the user's possession and isolate it for the purpose of transferring and receiving secure data only to and from that particular device.

While the present invention has been disclosed in connection with the preferred embodiment thereof, it should be understood that there may be other embodiments which fall within the spirit and scope of the invention as defined by the following claims.

What is claimed is:

1. For wireless devices, a secure data transfer apparatus comprising:
a) a cabinet moveable between an open position for receiving a wireless device and a closed position for sealing said wireless device within said cabinet;
b) at least one communication sensor inside said cabinet for transferring secure data to and from said wireless device;
c) a secure communications device connected to said at least one communication sensor and to a data source external to said cabinet for transferring secure data to and from said at least one communication sensor; and
d) a command device connected to said cabinet for operating said at least one communication sensor and directing the transfer of said secure data to and from said wireless device within said cabinet in said closed position.

2. The apparatus of claim 1 wherein the at least one communication sensor is selected from a group of communication sensors including RF and IR.

3. The apparatus of claim 1 further comprising multiple communication sensors.

4. The apparatus of claim 1 wherein the secure communications device comprises a hardwired connection to the at least one communication sensor and the data source.

5. The apparatus of claim 1 wherein the command device comprises a keyboard.

6. The apparatus of claim 1 wherein the data source comprises the Internet.

7. For wireless devices, a method of transferring secure data to and from a wireless device comprising the steps of:
a) providing a cabinet moveable between an open position for receiving the wireless device and a closed position for sealing the wireless device within the cabinet;
b) attaching at least one communication sensor inside the cabinet for transferring data to and from the wireless device;
c) connecting a secure communication device to the at least one communication sensor and to a data source external to said cabinet for transferring secure data to and from the at least one communication sensor;
d) connecting a command device to the cabinet for operating the at least one communication sensor and directing the transfer of secure data to and from the wireless device within the cabinet;
e) inserting the wireless device within the cabinet and placing the cabinet in the closed position; and
f) operating the command device and transferring secure data to and from the wireless device.

8. The method of claim 7 further comprising the step of selecting the at least one communication sensor from a group of communication sensors including RF and IR.

9. The method of claim 7 further comprising the step of attaching multiple communication sensors within the cabinet.

10. The method of claim 7 wherein the step of connecting a secure communications device includes a hardwire connection to the at least one communication sensor and to the data source.

11. The method of claim 7 wherein the step of connecting a command device comprises the step of connecting a keyboard to the cabinet.

12. The method of claim 7 wherein the step of connecting to a data source comprises the step of connecting to the Internet.

13. The method of claim 7 further comprising the step of selecting a wireless device from a group including PDAs, cellphones, smart cards, watches, and Internet pendants.

14. The method of claim 7 further comprising the step of locking the cabinet after the wireless device is placed within the cabinet and the cabinet is closed.

15. The method of claim 7 further comprising the step of testing the wireless device prior to transferring secure data to the wireless device.

16. In a cabinet moveable between an open position for receiving a wireless device and a closed position for sealing the wireless device within the cabinet, computer code recorded on a computer readable medium for secure data transfer comprising:
a) at least one communication sensor code for transferring secure data to and from said wireless device;
b) secure communication code linked to said at least one communication sensor code and to a data source external to said cabinet for transferring secure data to and from said at least one communication sensor code; and
c) command code linked to said cabinet for operating said at least one communication sensor code and directing the transfer of said secure data to and from said wireless device within said cabinet in said closed position.

17. The invention of claim 16 wherein the at least one communication sensor code is selected from a group of communication sensor codes including RF and IR.

18. The invention of claim 16 further comprising computer code for multiple communication sensors.

19. The invention of claim 16 wherein the command code comprises computer code for a keyboard.

20. The invention of claim 16 wherein the computer code for connecting to a data source comprises computer code for connecting to the Internet.
